(19) United States
(12) Patent Application Publication
(10) Pub. No.: US 2017/0089415 A1
(43) Pub. Date: Mar. 30, 2017

(54) METHOD FOR THE PRODUCTION OF A WET FRICTION LINING, AND WET FRICTION LINING

(71) Applicant: Schaeffler Technologies AG & Co. KG, Herzogenaurach (DE)

(72) Inventors: Jurgen Kroll, Buhl (DE); Stefan Steinmetz, Esslingen (DE)

(73) Assignee: Schaeffler Technologies AG & Co. KG, Herzogenaurach (DE)

(21) Appl. No.: 15/312,098

(22) PCT Filed: May 6, 2015
(86) PCT No.: PCT/DE2015/200303

§ 371 Date: Nov. 17, 2016

(30) Foreign Application Priority Data
May 21, 2014 (DE) 10 2014 209 662.6
Jun. 4, 2014 (DE) 10 2014 210 543.9
Jul. 21, 2014 (DE) 10 2014 214 086.2

(51) Int. Cl. F16D 69/00; F16D 13/60

(52) U.S. Cl. CPC F16D 69/00; F16D 13/60; F16D 2069/004; F16D 2069/005; F16D 2250/0061; F16D 2250/0069; F16D 2250/0038

(57) ABSTRACT

The invention relates to a method for producing a wet friction lining wherein an oil is delivered through pores to a device operated using oil. In a method in which oil delivery from the wet lining is adjustable regardless of the production process for the wet friction lining, the pores are formed using a perforation process.

### BACKGROUND

The method relates to a method for the production of a wet friction lining, in which oil is delivered through pores to a device operated using oil, as well as a wet friction lining.

Friction linings, which are used in devices operated using oil, such as clutches and duplex clutches, automatic transmissions, transducers, and lock-up and synchronizing units, serve to adjust the relative motion of the clutch disks in reference to each other. A two-layer friction material is known from DE 697 26 641 T2, which is made from a fibrous base material. This fibrous base material comprises a top layer and a bottom layer, which are connected to each other during a wet paper production process. Here the bottom layer is formed from a friction layer comprising fibers and/or fillers and/or friction particles. The top layer made from a friction material also includes fibers and/or fillers and/or friction particles and is formed on top of the bottom layer. Such friction material is particularly suited for the application in modern transmission systems and brake systems in the automotive industry, where it is used preferably in wet operating clutch systems.

Such wet friction linings are generated in a classical paper production process and subsequently subjected to a resin impregnation. The features of the wet friction lining are characterized, among other things, by the porosity, such as pore size and pore distribution, and a defined mechanical material behavior, which particularly describes the compression and recovery behavior over the life span. The adjustment of these features essentially results in the friction features of the material with the goal to ensure oil delivery of the friction contact via the switching process of the clutch. The raw paper materials, the paper production process, and the subsequent adhesion of the paper must be optimized for this behavior. The permeability embodied during the paper production process, particularly the one of the top layer, is here frequently subject to inconsistencies due to fluctuations in raw materials and processes so that the oil delivery, through a material structure that is inhomogeneous over the paper thickness, varies to a large extent.

### SUMMARY

The invention is based on the objective to provide a method for the production of a wet friction lining in which the oil delivery can be adjusted precisely to the respective conditions for application.

According to the invention the objective is attained such that the pores are formed by a perforation process. By the formation of the pores via the perforation method the permeability of the wet friction lining is adjusted directly to the respective conditions for application. The wet friction lining produced via perforation leads here to a faceplate effect during the oil delivery. The faceplate effect is here reproducible and can be adjusted with relatively low expense. Due to the fact that the separate perforation process occurs independent from the paper production process, the desired permeability of the wet friction lining can be easily adjusted.

Advantageously the pores are formed by laser perforation. This pore generating laser perforation process allows the adjustment of a wide range of pore diameters and a high number of aperture sequences in a predetermined period of time, selected for the method of application.

In one alternative the pores are formed by mechanic perforation. Another alternative is given in that the pores are formed by micro-perforation, preferably by electrostatic discharges. In wet friction linings treated with the different perforation methods the faceplate effect of the wet friction lining can be controlled with regards to the oil delivery and adjusted depending on the application at hand.

In one embodiment the top layer of the wet friction lining can be treated via perforation method and subsequently, preferably in a laminating process, applied onto the bottom layer. In this laminating process the top layer and the bottom layer of the wet friction lining are connected to each other by residual reactivity of the binder of the top layer and/or the bottom layer contained therein, with the residual binder being used as an adhesive.

Alternatively, the top layer is applied onto the bottom layer and subsequently the pores of the top layer are formed with the perforation method. The wet friction lining comprising two layers therefore exhibits higher stability for the production of pores and better handling features.

A further development of the invention relates to a wet friction lining for a device operated using oil, which has pores for the oil delivery to the device. In a wet friction lining in which the friction features can be adjusted precisely to the respective application process the pores generated by way of perforation are formed in a single-layer friction material and have a pore size and/or pore density depending on the perforation. By applying the perforation method the pore size can be selected at any time such that on the one hand the hydraulic faceplate effect of the wet friction lining is optimized and on the other hand any risk is avoided that the pores get clogged or smeared up, which can occur e.g., by decomposition products of the transmission oil.

Advantageously the friction material comprising pores generated by way of perforation forms a top layer arranged on a bottom layer, which in turn has higher porosity than the top layer. Due to the fact that the bottom layer has higher porosity, here the absorption and delivery dispensation of oil through the bottom layer is quickly possible. The hydraulic faceplate effect realized by the lesser porosity of the top layer leads to the fact that from the outside oil can penetrate and dissipate via this top layer with slow speeds only and thus oil can be delivered in a targeted fashion from the bottom layer via the top layer during the friction process. The top layer provided with pores can be adjusted optimally with regards to the friction behavior by way of the embodiment of the pores and by potentially used raw materials of the lining optimally adjusted to the desired friction behavior. The mechanical behavior of the bottom layer can be adjusted optimally, independent from the adjustment of the hydraulic faceplate effect. This way a functional separation is given between the top layer treated by perforation methods and the bottom layer.

In one variant here the top layer is connected to the bottom layer via lamination or a separate adhesive layer. With regards to the technical assembly this process can be performed very quickly and cost-effectively. The top layer can also be formed by a wet production process during the paper production or by a common paper lamination process, such as roller-coating, curtain coating, or spray coating.

In a further development the pores formed by way of perforation penetrate the top layer partially or entirely. The depth of the penetration of the pores in the top layer can be adjusted independent from the production process of the wet friction lining and depending on the perforation method used. Based on the use of the perforation method, here particular pore patterns can be implemented, i.e. the arrangement of the pores of the top layer of the wet friction lining influences the friction performance value of the wet friction lining. Furthermore, lining materials optimized for the function of the faceplate effect are used for the top layer, which for example represent high temperature-stable fibers and/or binders. This way an optimized adjustment occurs to the application conditions of the wet friction lining.

In one embodiment the top layer and/or the bottom layer comprise a paper-like material. This way, comparatively low-cost paper raw materials can be used for the wet friction lining.

Alternatively the first and/or the bottom layer are made from a thermoset synthetics and/or ceramic material. These materials are particularly advantageous for adjusting a strong hydraulic faceplate effect of the top layer.

In another embodiment the pores are formed continuously in a single-layer material or they have arbitrary depths and predetermined geometric arrangements.

In a further development the diameter of the pores is round or oval or angled.

### BRIEF DESCRIPTION OF THE DRAWINGS

The invention allows numerous embodiments. One of them shall be explained in greater detail based on the FIGURE shown in the drawing.

Shown is:

FIG. 1 an exemplary embodiment of a wet friction lining according to the invention.

### DETAILED DESCRIPTION OF THE PREFERRED EMBODIMENTS

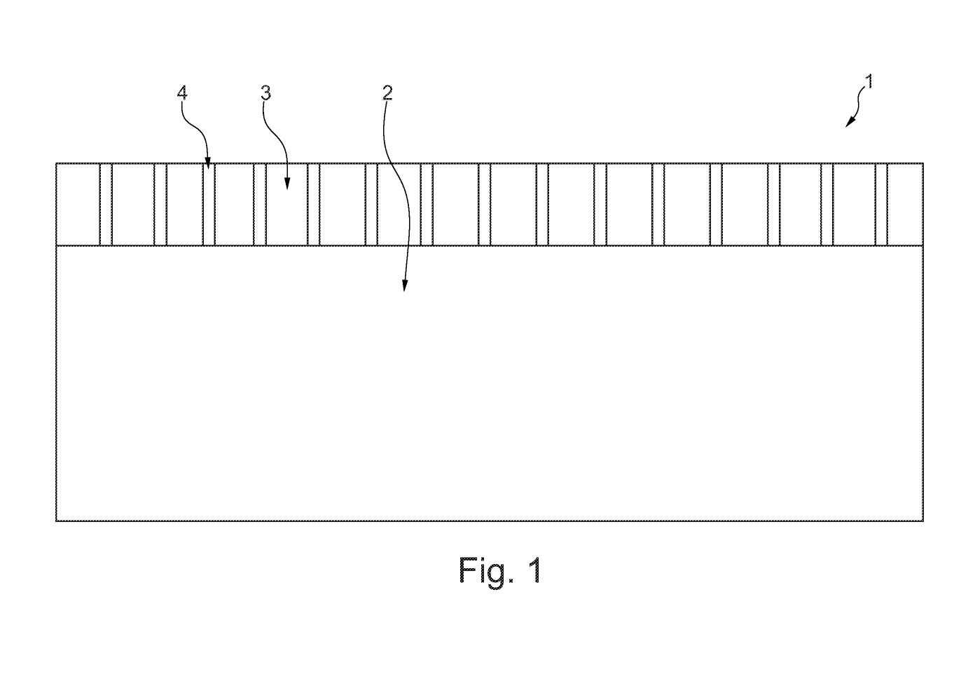

FIG. 1 shows an exemplary embodiment of a wet friction lining 1 according to the invention as used for a clutch of a motor vehicle. The wet friction lining 1 comprises two layers. A bottom layer 2 exhibits high porosity in order to absorb oil. Based on the high porosity this bottom layer 2 has a high oil penetration and oil delivery speed. The top layer 3 arranged on this bottom layer has however a lower oil penetration speed, which means that the top layer 3 exhibits a lower permeability compared to the bottom layer 2. The layers 2 and 3 are connected to each other by a lamination process.

The top layer 3 here has pores 4, which are formed by way of a laser perforation process. This laser perforation process occurs here independent from the actual production process of the wet friction lining 1. With the laser perforation method the patterns of the pores 4, the pore size, and also the pore depth are adjustable. In the present case the pores 4 penetrate the entire top layer 3. The layer thickness of the top layer 3 and the pore density can here be adjusted precisely and depending on the application process, exactly adjusting the hydraulic faceplate effect of the top layer 3 and thus the oil delivery from the bottom layer 2 to the environment of the clutch due to the pressure of the wet friction layer 1 applied.

In a particularly beneficial production process the bottom layer 2 and the top layer 3 form a paper composite. These two layers, 2 and 3 are produced in a paper production process and laminated or directly connected to each other during the paper production process. After the completion of the wet friction layer 1 here pores 4 are entered into the top layer 3 by way of laser perforation. Using the laser perforation a wide range of perforation diameters can be yielded from 50 nm to 500 μm. The aperture sequence yielded within one second during the laser perforation process ranges from 1.5 to 16 million pores. This is possible at a pore density up to 500 pores per cm².

Alternatively it is also possible that the bottom layer 2 and the top layer 3 are produced independent from each other, with the top layer 3 initially being provided with pores 4 by way of laser perforation and subsequently applied on the bottom layer 2 by way of lamination or via a separate adhesive layer.

In another embodiment the top layer 3 of the wet friction lining 1 may be provided with a closed surface, which is possible e.g., by a calendaring process. Subsequently the opening of the surface of the top layer 3 occurs by way of laser perforation. In laser perforation the pore depth can be set to different depths. They may here penetrate the top layer 3 only partially or completely as already described. However, the option is also given that the pore depth penetrates to the bottom paper.

The method explained is however not limited to a laser perforation method. For example, mechanical perforation methods can also be performed, such as a hot-needle or cold-needle perforation methods.

Furthermore, electrostatic micro-perforation or nano-perforation can be applied over the entire area or over certain zones, with here the diameter of the apertures that can be realized may range from 0.1 to 3000 μm for the pores 4. By developments in the framing topology for the generation of very fine, power-controlled high-voltage discharge pulses with short durations ranging from 0.5 to 20 μs and individual charge energy from 0.2 to 1 mJ nano-technology can be used for sub-micro perforation in this range.

### LIST OF REFERENCE CHARACTERS

1 wet friction lining

2 bottom layer

3 top layer

4 pores

1. A method for the production of a wet friction lining, in which oil is delivered through pores to a device operated using oil, the method comprising forming the pores in the wet friction lining by a perforation process.

2. The method according to claim 1, wherein the pores are formed by laser perforation.

3. The method according to claim 1, wherein the pores are formed by mechanical perforation.

4. The method according to claim 1, wherein the pores are formed by electrostatic micro-perforation.

5. The method according to claim 1, further comprising treating a top layer of the wet friction lining by the perforation process and subsequently applying the top layer on a bottom layer.

6. The method according to claim 1, further comprising applying a top layer of the wet friction lining on a bottom layer and subsequently forming the pores of the top layer by the perforation process.

7. A wet friction lining for a device operated using oil, which comprises pores for oil delivery to the device, the pores are generated as perforations in a single layer friction lining and have at least one of a pore size or pore density based on the perforations.

8. The wet friction lining according to claim 7, wherein the friction lining comprising the pores generated as perforations forms a top layer which is arranged on a bottom layer having a higher porosity than the top layer.

9. The wet friction lining according to claim 8, wherein the top layer comprising the pores generated as perforations is connected to the bottom layer by lamination or a separate adhesive layer.

10. The wet friction lining according to claim 8, wherein the pores formed as perforations penetrate the top layer partially or completely.

11. The method according to claim 4, wherein the electrostatic microperformation is performed using an electrostatic discharge.

12. The method according to claim 5, wherein the top layer is laminated to the bottom layer.
